(19) United States
(12) Patent Application Publication
(10) Pub. No.: US 2025/0135548 A1
(43) Pub. Date: May 1, 2025

(54) THREE-DIMENSIONAL PRINTING

(71) Applicants: Hewlett-Packard Development Company, L.P., Spring, TX (US); Nanyang Technological University, Singapore (SG)

(72) Inventors: Karl DAVIDSON, Singapore (SG); Po-Ju CHIANG, Singapore (SG); Matteo SEITA, Singapore (SG); Kristopher J. ERICKSON, Palo Alto, CA (US); Lihua ZHAO, Palo Alto, CA (US)

(73) Assignees: Hewlett-Packard Development Company, L.P., Spring, TX (US); Nanyang Technological University, Singapore (SG)

(21) Appl. No.: 18/685,151

(22) PCT Filed: Aug. 20, 2021
(86) PCT No.: PCT/US2021/046926

§ 371 Date: Feb. 20, 2024

(51) Int. Cl. B22F 10/64; B22F 10/14; B33Y 10/00; B33Y 40/20; B33Y 80/00

(52) U.S. Cl. CPC B22F 10/64; B22F 10/14; B33Y 10/00; B33Y 40/20; B22F 2303/05; B33Y 80/00

(57) ABSTRACT

An example of a three-dimensionally printed object includes a bulk portion having a ferritic microstructure; and a site-specific alloyed section having a pearlite microstructure. The three-dimensionally printed object may be generated using different examples of a three-dimensional (3D) printing method. Each example of the 3D printing method utilizes a two-stage heat treatment.

### BACKGROUND

Three-dimensional (3D) printing is an additive manufacturing process used to make three-dimensional solid parts from a digital model. 3D printing techniques are considered additive manufacturing processes because they involve the application of successive layers of material (which, in some examples, may include build material, binder and/or other printing liquid(s), or combinations thereof). This is unlike traditional machining processes, which often rely upon the removal of material to create the final part. 3D printing is often used in rapid product prototyping, mold generation, mold master generation, and short run manufacturing for mass personalization and customization of goods.

### BRIEF DESCRIPTION OF THE DRAWINGS

Features of examples of the present disclosure will become apparent by reference to the following detailed description and drawings, in which like reference numerals correspond to similar, though perhaps not identical, components. For the sake of brevity, reference numerals or features having a previously described function may or may not be described in connection with other drawings in which they appear.

FIG. 1 is a flow diagram illustrating one example of a 3D printing method;

FIG. 2 is a flow diagram illustrating another example of a 3D printing method;

FIG. 3 graphically illustrates one example of the 3D printing methods disclosed herein;

FIG. 4 graphically illustrates another example of the 3D printing methods disclosed herein;

FIG. 5 is a schematic, perspective view of an example of a 3D object including two discrete site-specific alloyed sections;

FIG. 6 is a schematic, perspective view of another example of a 3D object including two discrete site-specific alloyed sections;

FIG. 7A is a photograph, reproduced in black and white, of an example 3D intermediate structure;

FIG. 7B is a graph of the two-stage heat treatment used to sinter the example 3D intermediate structure of FIG. 7A;

FIG. 7C is a photograph of the example 3D object formed after sintering of the example 3D intermediate structure of FIG. 7A;

FIGS. 7D-7F are optical microscopy images of the example 3D object formed after sintering of the example 3D intermediate structure of FIG. 7A, where FIG. 7E and FIG. 7F are higher resolution images of different portions of the of the example 3D object;

FIG. 7G is an optical microscopy image of a portion of the interface of a carbon-rich region and a carbon-poor region of the example 3D object formed after sintering of the example 3D intermediate structure of FIG. 7A;

FIG. 8A is a graph of a comparative single-stage heat treatment used to generate a first comparative example 3D object;

FIG. 8B is an optical microscopy image of the first comparative example 3D object;

FIG. 9A is a graph of a comparative two-stage heat treatment used to generate a second comparative example 3D object; and

FIG. 9B is an optical microscopy image of the second comparative example 3D object.

### DETAILED DESCRIPTION

In the three-dimensional (3D) printing methods disclosed herein, a binder fluid is selectively applied to a layer of build material on a build platform, thereby patterning a selected region of the layer, and then another layer of the build material is applied thereon. The binder fluid is then selectively applied to this other layer, and these processes are repeated to form a green part (referred to herein as an “intermediate structure”) of a 3D object that is ultimately to be formed. The binder fluid may be capable of penetrating the layer of the build material onto which it is applied, and/or spreading around an exterior surface of the build material and filling void spaces between particles of the build material. The binder fluid can include binder particles, such as polymer latex particles, that when cured, temporarily hold the build material of the 3D intermediate structure together.

In addition to the binder fluid, the 3D printing methods disclosed herein also utilize an alloying agent to pattern area(s) of the build material that are to become site-specific alloyed sections of the 3D object. The alloying agent is jettable via an inkjet print head and thus can be deposited to a desirable location of the build material at the voxel level.

The 3D printing methods involve a two-stage heat treatment that has been found to minimize the diffusion of the alloying agent to areas outside of the site-specific alloyed sections. As such, the term “site-specific alloyed section” refers to a portion of the 3D object that has an alloyed composition, where a size and shape of the portion having the alloyed composition are respectively and substantially equivalent to a size and shape of a corresponding area of the build material that is patterned with the alloying agent and that is intended to become the portion having the alloyed composition. The phrase “substantially equivalent to,” in terms of size, means that each dimension of the portion of the 3D object having the alloyed composition is within 1 mm of a corresponding dimension of the area of the build material that is patterned with the alloying agent. In some examples, each dimension of the portion of the 3D object having the alloyed composition is within from about 0.3 mm to about 0.5 mm of the corresponding dimension of the area of the build material that is patterned with the alloying agent. Although the diffusion of the alloying agent may vary depending upon the droplet size, the build material size, etc., the two-stage heat treatment described herein limits this diffusion compared to other heat treatment schedules. The phrase “substantially equivalent to,” in terms of shape, means that the shape of the portion of the 3D object having the alloyed composition resembles the shape of the build material that is patterned with the alloying agent.

Throughout this disclosure, a weight percentage that is referred to as “wt % active” refers to the loading of an active component of a stock formulation that is present, e.g., in a fusing agent, detailing agent, etc. For example, an energy absorber, such as carbon black, may be present in a water-based formulation (e.g., a stock solution or dispersion) before being incorporated into the fusing agent vehicle. In this example, the wt % active of the carbon black accounts for the loading (as a weight percent) of the carbon black solids that are present in the fusing agent, and does not account for the weight of the other components (e.g., water, etc.) that are present in the stock solution or dispersion with the carbon black. Also as used herein, a volume percentage refers to the ratio of the volume of a solute or solid that is present in solution or dispersion, relative to the total volume of the solution or dispersion.

### Alloying Agent

Examples of the alloying agent include an alloying element and a vehicle.

The alloying element may be any element that can be dissolved or dispersed into the vehicle to generate a jettable fluid and that can alloy with a metal-based build material. Examples of suitable alloying elements include platinum group metals (i.e., ruthenium, rhodium, palladium, osmium, iridium, and platinum), group 11 elements (i.e., copper, silver, gold), carbon (e.g., carbon black), group 6 elements (i.e., molybdenum, tungsten, chromium), boron, sulfur, silicon, nickel, tin, indium, magnesium, vanadium, niobium, titanium, manganese, zirconium, scandium, yttrium, lanthanum, and cerium. It is to be understood that carbon, boron, bismuth, sulfur, nickel, silicon, niobium, vanadium, zirconium, scandium, manganese, and molybdenum may be used at ambient conditions in small particle form, in part because they are not easily oxidized in this form. The carbon alloying elements may be in the form of carbon nanoparticles, carbon black nanoparticles, carbon nanotubes or graphene. The molybdenum or tungsten alloying elements may be in the form, respectively, of a molybdate (e.g., ammonium molybdate or sodium molybdate) or a tungstate (e.g., ammonium tungstate or sodium tungstate), or molybdenum- or tungsten-containing organometallics, or as molybdenum or tungsten nanoparticles. Copper, gold, and any of the platinum group metals may be in the form of nanoparticles. The boron alloying element may be in the form of borate (e.g., sodium borate or another water-soluble borate species) or boron nanoparticles. The chromium alloying element may be in the form of a salt containing chromium in an oxidized state (e.g., chromate salt), or nanoparticles, or an organometallic source of chromium (e.g., chromium hexacarbonyl or (benzene) chromium tricarbonyl). Titanium, magnesium, zirconium, and scandium elements can take the form of oxides. Yttrium, lanthanum, zirconium, magnesium, and cerium elements can be deposited in the form of oxide dispersants.

Any of the alloying elements that are included as nanoparticles may have an average particle size (e.g., average diameter of the particles) ranging from about 2 nm to about 100 nm. A distribution of the alloying element nanoparticles (D10 to D90) may range from about 10 nm to about 75 nm with a median diameter (D50) of about 50 nm. In an example, the distribution values (D10, D50, D90) may be weighted by volume. The individual particle sizes can be outside of the distribution range, as D50 is defined as the median diameter at which about half of the particles are larger than the D50 value and about half of the other particles are smaller than the D50 value. Similarly, about 10% of the particles in the distribution are below the D10 value and about 90% of the particles in the distribution are below the D90 value. As noted, in an example, the distribution values may be volume-weighted mean diameters. In another example, the longest dimension of a carbon nanotube used as an alloying element (e.g., its length) may range from about 2 nm to about 100 nm.

The alloying element may be present in the alloying agent in an amount that enables good jettability from a desired inkjet printhead. When metal nanoparticles, carbon nanoparticles, or carbon nanotubes are included in the alloying agent, the amount may range from about 0.5 vol % to about 10 vol %, based on the total volume of the alloying agent. In one example, carbon nanoparticles may be present in the alloying agent in an amount of about 5 vol %. When metal salts (e.g., molybdate, tungstates, borates, or chromates) are included in the alloying agent, the amount may range from about 1 vol % to about 60 vol %, based on the total volume of the alloying agent. The amounts set forth herein may be varied if other jetting technologies are to be used. In terms of weight percent, the alloying element may be present in an amount ranging from about 0.5 wt % active to about 60 wt % active based on the total weight of the alloying agent, and these percentages may take into account the density of the particular alloying element.

The alloying agent also includes a vehicle. By “vehicle,” it is meant that the liquid(s) into which the alloying element is introduced. In an example, the vehicle may include at least some water (e.g., deionized water). The amount of water may depend, in part, on the type of jetting architecture that is to be used. For example, if the alloying agent is to be jettable via thermal inkjet printing, water may make up 35 wt % or more of the alloying agent. In one example, water makes up from about 70 wt % to about 75 wt % of the total weight of the alloying agent. For another example, if the alloying agent is to be jettable via piezoelectric inkjet printing, water may make up from about 25 wt % to about 30 wt % of the total weight of the alloying agent, and 35 wt % or more of the total weight of the alloying agent may be an organic co-solvent, such as ethanol, isopropanol, acetone, etc. Other example vehicles include no water and include one or more of the co-solvents disclosed herein.

In addition to, or as an alternative to water, any example of the vehicle may include a (co-)solvent and a surfactant. Other additives may also be included, such as antimicrobial agent(s), dispersant(s), chelating agent(s), pH adjuster(s), and/or combinations thereof. In an example, the vehicle of the alloying agent includes a co-solvent, a surfactant, and a balance of water. In another example, the vehicle of the alloying agent consists of a co-solvent, a surfactant, and a balance of water. In still another example, the vehicle of the alloying agent consists of a co-solvent, a surfactant, an additive selected from the group consisting of antimicrobial agent(s), dispersant(s), chelating agent(s), and/or combinations thereof, and a balance of water.

Classes of organic (co-)solvents that may be used in the alloying agent include aliphatic alcohols, aromatic alcohols, diols, glycol ethers, polyglycol ethers, lactams, formamides, acetamides, glycols, and long chain alcohols. Examples of these co-solvents include primary aliphatic alcohols, secondary aliphatic alcohols, 1,2-alcohols, 1,3-alcohols, 1,5-alcohols, 1,6-hexanediol or other diols (e.g., 1,5-pentanediol, 2-methyl-1,3-propanediol, etc.), ethylene glycol alkyl ethers, propylene glycol alkyl ethers, higher homologs (C6-C12) of polyethylene glycol alkyl ethers, triethylene glycol, tetraethylene glycol, tripropylene glycol methyl ether, N-alkyl caprolactams, unsubstituted caprolactams, 2-pyrrolidone, 1-methyl-2-pyrrolidone, N-(2-hydroxyethyl)-2-pyrrolidone, both substituted and unsubstituted formamides, both substituted and unsubstituted acetamides, and the like. Other examples of organic co-solvents include dimethyl sulfoxide (DMSO), isopropyl alcohol, ethanol, pentanol, acetone, or the like.

Some examples of suitable co-solvents include water-soluble high-boiling point solvents, which have a boiling point of at least 120° C., or higher. Some examples of high-boiling point solvents include 2-pyrrolidone (i.e., 2-pyrrolidinone, boiling point of about 245° C.), 1-methyl-2-pyrrolidone (boiling point of about 203° C.), N-(2-hydroxyethyl)-2-pyrrolidone (boiling point of about 140° C.), 2-methyl-1,3-propanediol (boiling point of about 212° C.), and combinations thereof.

The co-solvent(s) may be present in the alloying agent in a total amount ranging from about 1 wt % to about 50 wt % based upon the total weight of the alloying agent, depending upon the jetting architecture of the applicator. In an example, the total amount of the co-solvent(s) present in the alloying agent is about 5 wt % based on the total weight of the alloying agent. In another example, the total amount of the co-solvent(s) present in the alloying agent is about 20 wt % based on the total weight of the alloying agent.

In some examples, the vehicle of the alloying agent includes surfactant(s) to improve the jettability of the alloying agent. Examples of suitable surfactants include a self-emulsifiable, non-ionic wetting agent based on acetylenic diol chemistry (e.g., SURFYNOL® SEF from Evonik Degussa), a non-ionic fluorosurfactant (e.g., CAPSTONE® fluorosurfactants, such as CAPSTONE® FS-35, from Chemours), and combinations thereof. In other examples, the surfactant is an ethoxylated low-foam wetting agent (e.g., SURFYNOL® 440 or SURFYNOL® CT-111 from Evonik Degussa) or an ethoxylated wetting agent and molecular defoamer (e.g., SURFYNOL® 420 from Evonik Degussa). Still other suitable surfactants include non-ionic wetting agents and molecular defoamers (e.g., SURFYNOL® 104E from Evonik Degussa) or water- soluble, non-ionic surfactants (e.g., TERGITOL™ TMN-6, TERGITOL™ 15-S-7, or TERGITOL™ 15-S-9 (a secondary alcohol ethoxylate) from The Dow Chemical Company or TEGO® Wet 510 (polyether siloxane) available from Evonik Degussa). Yet another suitable surfactant includes alkyldiphenyloxide disulfonate (e.g., the DOWFAX™ series, such a 2A1, 3B2, 8390, C6L, C10L, and 30599, from The Dow Chemical Company).

Whether a single surfactant is used or a combination of surfactants is used, the total amount of surfactant(s) in the alloying agent may range from about 0.01 wt % active to about 1 wt % active based on the total weight of the alloying agent. In an example, the total amount of surfactant(s) in the alloying agent may be about 0.75 wt % active based on the total weight of the alloying agent.

In some examples, the vehicle of the alloying agent includes an antimicrobial agent. Antimicrobial agents are also known as biocides and/or fungicides. Examples of suitable antimicrobial agents include the NUOSEPT® (Ashland Inc.), UCARCIDE™ or KORDEK™ or ROCIMA™ (Dow Chemical Co.), PROXEL® (Arch Chemicals) series, ACTICIDER B20 and ACTICIDER M20 and ACTICIDER MBL (blends of 2-methyl-4-isothiazolin-3-one (MIT), 1,2-benzisothiazolin-3-one (BIT) and Bronopol) (Thor Chemicals), AXIDE™ (Planet Chemical), NIPACIDE™ (Clariant), blends of 5-chloro-2-methyl-4-isothiazolin-3-one (CIT or CMIT) and MIT under the tradename KATHON™ (Dow Chemical Co.), and combinations thereof.

In an example, the total amount of antimicrobial agent(s) in the alloying agent ranges from about 0.01 wt % active to about 0.05 wt % active (based on the total weight of the alloying agent). In another example, the total amount of antimicrobial agent(s) in the alloying agent is about 0.044 wt % active (based on the total weight of the alloying agent).

In some examples, the vehicle of the alloying agent includes dispersant(s). Some specific examples of suitable dispersants include a water-soluble acrylic acid polymer (e.g., CARBOSPERSE® K7028 available from Lubrizol), water-soluble styrene-acrylic acid copolymers/resins (e.g., JONCRYL® 296, JONCRYL® 671, JONCRYL® 678, JONCRYL® 680, JONCRYL® 683, JONCRYL® 690, etc. available from BASF Corp.), a high molecular weight block copolymer with pigment-affinic groups (e.g., DISPERBYK®-190 available BYK Additives and Instruments), or water-soluble styrene-maleic anhydride copolymers/resins.

Whether a single dispersant is used or a combination of dispersants is used, the total amount of dispersant(s) in the alloying agent may range from about 1 wt % active to about 10 wt % active based on the total weight of the alloying agent. In an example, the total amount of dispersant(s) in the alloying agent may be about 0.75 wt % active based on the total weight of the alloying agent.

Chelating agents (or sequestering agents) may be included in the vehicle of the alloying agent to eliminate the deleterious effects of heavy metal impurities. Examples of chelating agents include disodium ethylenediaminetetraacetic acid (EDTA-Na), ethylene diamine tetra acetic acid (EDTA), and methylglycinediacetic acid (e.g., TRILON® M from BASF Corp.).

Whether a single chelating agent is used or a combination of chelating agents is used, the total amount of chelating agent(s) in the alloying agent may range from greater than 0 wt % active to about 1 wt % active based on the total weight of the alloying agent. In an example, the chelating agent(s) is/are present in the alloying agent in an amount of about 0.08 wt % active (based on the total weight of the alloying agent).

A pH adjuster may also be used to adjust the pH of alloying agent. In an example, the pH of the alloying agent ranges from about 7.5 to about 9.0. In another example, the pH of the alloying agent ranges from about 8.0 to about 8.5. In some examples, a buffer may be used as the pH adjuster. An example of a suitable buffer is MOPS (3-(N-morpholino) propanesulfonic acid), and an example of a suitable amount of the buffer ranges from about 0.1 wt % active to about 0.2 wt % active based on the total weight of the alloying agent.

### Binder Fluid

The binder fluid is a fluid that includes water and polymer particles that are effective for binding layers of particulate build material when forming a 3D intermediate structure.

In some examples, the polymer particles are latex particles. Latex particles refer to any polymer (homopolymer, co-polymer, or heteropolymer) that is capable of being dispersed in an aqueous medium.

The polymer (latex) particles may have several different morphologies. In one example, the polymer particles can include two different copolymer compositions, which may be fully separated core-shell polymers, partially occluded mixtures, or intimately comingled as a polymer solution. In another example, the polymer particles can be individual spherical particles containing polymer compositions of hydrophilic (hard) component(s) and/or hydrophobic (soft) component(s) that can be interdispersed. In one example, the interdispersion can be according to IPN (interpenetrating networks) although it is contemplated that the hydrophilic and hydrophobic components may be interdispersed in other ways. In yet another example, the polymer particles can be composed of a hydrophobic core surrounded by a continuous or discontinuous hydrophilic shell. For example, the particle morphology can resemble a raspberry, in which a hydrophobic core can be surrounded by several smaller hydrophilic particles that can be attached to the core. In yet another example, the polymer particles can include 2, 3, or 4 or more relatively large polymer particles that can be attached to one another or can surround a smaller polymer core. In a further example, the polymer particles can have a single phase morphology that can be partially occluded, can be multiple-lobed, or can include any combination of any of the morphologies disclosed herein.

In some examples, the polymer (latex) particles can be homopolymers. In other examples, the polymer (latex) particles can be heteropolymers or copolymers. In an example, a heteropolymer can include a hydrophobic component and a hydrophilic component. In this example, the heteropolymer can include a hydrophobic component that can include from about 65% to about 99.9% (by weight of the heteropolymer), and a hydrophilic component that can include from about 0.1% to about 35% (by weight of the heteropolymer). In one example, the hydrophobic component can have a lower glass transition temperature than the hydrophilic component.

Examples of monomers that may be used to form the hydrophobic component of the heteropolymer polymer (latex) particles include C4 to C8 alkyl acrylates or methacrylates, styrene, substituted methyl styrenes, polyol acrylates or methacrylates, vinyl monomers, vinyl esters, ethylene, maleate esters, fumarate esters, itaconate esters, or the like. Some specific example monomers can include, C1 to C20 linear or branched alkyl (meth)acrylate, alicyclic (meth)acrylate, alkyl acrylate, styrene, methyl styrene, polyol (meth)acrylate, hydroxyethyl (meth)acrylate, or a combination thereof. In one specific class of examples, the polymer (latex) particles can be a styrene (meth)acrylate copolymer. In still another example, the polymer (latex) particles can include a copolymer with copolymerized methyl methacrylate being present at about 50 wt % or greater, or copolymerized styrene being present at about 50 wt % or greater. Both methyl methacrylate and styrene can be present, with one or the other being present at about 50 wt % or greater.

The term “(meth)acrylate” or “(meth)acrylic acid” or the like refers to monomers, copolymerized monomers, etc., that can either be acrylate or methacrylate (or a combination of both), or acrylic acid or methacrylic acid (or a combination of both). In some examples, the terms “(meth)acrylate” and “(meth)acrylic acid” can be used interchangeably, as acrylates and methacrylates are salts and esters of acrylic acid and methacrylic acid, respectively. Furthermore, mention of one compound over another can be a function of pH. Furthermore, even if the monomer used to form the polymer was in the form of a (meth)acrylic acid during preparation, pH modifications during preparation or subsequently when added to an ejectable fluid, such as a binder fluid, can impact the nature of the moiety as well (acid form vs. salt or ester form). Thus, a monomer or a moiety of a polymer described as (meth)acrylic acid or as (meth)acrylate should not be read so rigidly as to not consider relative pH levels, ester chemistry, and other general organic chemistry concepts.

In still other examples, the polymer (latex) particles in the binder fluid include polymerized monomers of vinyl chloride, vinylidene chloride, vinylbenzyl chloride, vinyl ester, styrene, ethylene, maleate esters, fumarate esters, itaconate esters, a-methyl styrene, p-methyl styrene, methyl methacrylate, hexyl acrylate, hexyl methacrylate, hydroxyethyl acrylate, butyl acrylate, butyl methacrylate, ethyl acrylate, ethyl methacrylate, propyl acrylate, propyl methacrylate, 2-ethylhexyl acrylate, 2-ethylhexyl methacrylate, octadecyl acrylate, octadecyl methacrylate, stearyl methacrylate, 2-phenoxyethyl methacrylate, isobornyl acrylate, tetrahydrofurfuryl acrylate, benzyl methacrylate, benzyl acrylate, ethoxylated nonyl phenol methacrylate, isobornyl methacrylate, ethylene glycol dimethacrylate, diethylene glycol dimethacrylate, triethylene glycol dimethacrylate, cyclohexyl methacrylate, trimethyl cyclohexyl methacrylate, t-butyl methacrylate, n-octyl methacrylate, lauryl acrylate, lauryl methacrylate, trydecyl methacrylate, alkoxylated tetrahydrofurfuryl acrylate, isodecyl acrylate, dimethyl maleate, dioctyl maleate, acetoacetoxyethyl methacrylate, diacetone acrylamide, N-vinyl imidazole, N-vinylcarbazole, N-Vinyl-caprolactam, pentaerythritol tri-acrylate, pentaerythritol tetra-acrylate, pentaerythritol tri-methacrylate, pentaerythritol tetra-methacrylate, glycidol acrylate, glycidol methacrylate, tetrahydrofuryl acrylate, tetrahydrofuryl methacrylate, diacetone acrylamide, t-butyl acrylamide, divinylbenzene, 1,3-butadiene, acrylonitrile, methacrylonitrile, combinations thereof, derivatives thereof, or mixtures thereof. These monomers include low glass transition temperature (Tg) monomers that can be used to form the hydrophobic component of a heteropolymer.

In some examples, a composition of the polymer (latex) particles can include acidic monomer(s). In some examples, the acidic monomer content can range from 0.1 wt % to 5 wt %, from 0.5 wt % to 4 wt %, or from 1 wt % to 2.5 wt % of the polymer particles with the remainder of the polymer particle being composed of non-acidic monomers. Example acidic monomers can include acrylic acid, methacrylic acid, ethacrylic acid, dimethylacrylic acid, maleic anhydride, maleic acid, vinylsulfonate, cyanoacrylic acid, vinylacetic acid, allylacetic acid, crotonoic acid, fumaric acid, itaconic acid, sorbic acid, angelic acid, cinnamic acid, styrylacrylic acid, citraconic acid, glutaconic acid, aconitic acid, phenylacrylic acid, acryloxypropionic acid, aconitic acid, phenylacrylic acid, acryloxypropionic acid, vinylbenzoic acid, N-vinylsuccinamidic acid, mesaconic acid, methacroylalanine, acryloylhydroxyglycine, sulfoethyl methacrylic acid, sulfopropyl acrylic acid, styrene sulfonic acid, sulfoethylacrylic acid, 2-methacryloyloxymethane-1-sulfonic acid, 3-methacryoyloxypropane-1-sulfonic acid, 3-(vinyloxy)propane-1-sulfonic acid, ethylenesulfonic acid, vinyl sulfuric acid, 4-vinylphenyl sulfuric acid, ethylene phosphonic acid, vinyl phosphoric acid, vinyl benzoic acid, 2-acrylamido-2-methyl-1-propanesulfonic acid, combinations thereof, derivatives thereof, or mixtures thereof. These acidic monomers are hydrophilic monomers that have a higher Tg than the low Tg hydrophobic monomers described herein. These acidic monomers can be used to form the hydrophilic component of a heteropolymer. Other examples of high Tg hydrophilic monomers can include acrylamide, methacrylamide, monohydroxylated monomers, monoethoxylated monomers, polyhydroxylated monomers, or polyethoxylated monomers.

In an example, the selected monomer(s) can be polymerized to form a polymer, heteropolymer, or copolymer with a co-polymerizable dispersing agent. The co-polymerizable dispersing agent can be a polyoxyethylene compound, such as a HITENOL® compound (Montello Inc.) e.g., polyoxyethylene alkylphenyl ether ammonium sulfate, sodium polyoxyethylene alkylether sulfuric ester, polyoxyethylene styrenated phenyl ether ammonium sulfate, or mixtures thereof.

Any suitable polymerization process can be used to form the polymer (latex) particles. In some examples, an aqueous dispersion of polymer (latex) particles can be produced by emulsion polymerization or co-polymerization of any of the above monomers.

In one example, the polymer (latex) particles can be prepared by polymerizing high Tg hydrophilic monomers to form the high Tg hydrophilic component and attaching the high Tg hydrophilic component onto the surface of the low Tg hydrophobic component. In another example, the polymer (latex) particles can be prepared by polymerizing the low Tg hydrophobic monomers and the high Tg hydrophilic monomers at a ratio of the low Tg hydrophobic monomers to the high Tg hydrophilic monomers that ranges from 5:95 to 30:70. In this example, the low Tg hydrophobic monomers can dissolve in the high Tg hydrophilic monomers. In yet another example, the polymer (latex) particles can be prepared by polymerizing the low Tg hydrophobic monomers, then adding the high Tg hydrophilic monomers. In this example, the polymerization process can cause a higher concentration of the high Tg hydrophilic monomers to polymerize at or near the surface of the low Tg hydrophobic component. In still another example, the polymer (latex) particles can be prepared by copolymerizing the low Tg hydrophobic monomers and the high Tg hydrophilic monomers, then adding additional high Tg hydrophilic monomers. In this example, the copolymerization process can cause a higher concentration of the high Tg hydrophilic monomers to copolymerize at or near the surface of the low Tg hydrophobic component.

Other suitable techniques, specifically for generating a core-shell structure, can include grafting a hydrophilic shell onto the surface of a hydrophobic core, copolymerizing hydrophobic and hydrophilic monomers using ratios that lead to a more hydrophilic shell, adding hydrophilic monomer (or excess hydrophilic monomer) toward the end of the copolymerization process so there is a higher concentration of hydrophilic monomer copolymerized at or near the surface, or any other method that can be used to generate a more hydrophilic shell relative to the core.

In one specific example, the low Tg hydrophobic monomers can be selected from the group consisting of C4 to C8 alkyl acrylate monomers, C4 to C8 alkyl methacrylate monomers, styrene monomers, substituted methyl styrene monomers, vinyl monomers, vinyl ester monomers, and combinations thereof; and the high Tg hydrophilic monomers can be selected from acidic monomers, unsubstituted amide monomers, alcoholic acrylate monomers, alcoholic methacrylate monomers, C1 to C2 alkyl acrylate monomers, C1 to C2 alkyl methacrylate monomers, and combinations thereof. The resulting polymer latex particles can exhibit a core-shell structure, a mixed or intermingled polymeric structure, or some other morphology.

In some examples, the polymer (latex) polymer can have a weight average molecular weight (Mw, g/mol) that can range from about 5,000 Mw to about 2,000,000 Mw. In yet other examples, the weight average molecular weight can range from about 100,000 Mw to about 1,000,000 Mw, from about 100,000 Mw to about 500,000 Mw, from about 150,000 Mw to about 300,000 Mw, or from about 50,000 Mw to about 250,000 Mw. Weight average molecular weight (Mw) can be measured by Gel Permeation Chromatography with polystyrene standard.

In some examples, the polymer (latex) particles can be latent and can be activated by heat (which may be applied iteratively during 3D intermediate structure formation or after 3D intermediate structure formation). In these instances, the activation temperature can correspond to the minimum film formation temperature (MFFT) or a glass transition temperature (Tg) which can be greater than ambient temperature. As mentioned herein, “ambient temperature” may refer to room temperature (e.g., ranging about 18° C. to about 22° C.). In one example, the polymer (latex) particles can have a MFFT or Tg that can be at least about 15° C. greater than ambient temperature. In another example, the MFFT or the Tg of the bulk material (e.g., the more hydrophobic portion) of the polymer (latex) particles can range from about 25° C. to about 200° C. In another example, the polymer (latex) particles can have a MFFT or Tg ranging from about 40° C. to about 120° C. In yet another example, the polymer (latex) particles can have a MFFT or Tg ranging from about 0° C. to about 150° C. In a further example, the polymer latex particles can have a Tg that can range from about −20° C. to about 130° C., or in another example from about 60° C. to about 105° C. At a temperature above the MFFT or the Tg of a latent latex polymer particle, the polymer particles can coalesce and can bind materials, such as the metal-based build material particles.

The polymer (latex) particles can have an average particle size (e.g., average diameter of the particles) that can be jetted via thermal ejection or printing, piezoelectric ejection or printing, drop-on-demand ejection or printing, continuous ejection or printing, etc. In an example, the average particle size of the polymer (latex) particles can range from about 1 nm to about 400 nm. In yet other examples, a particle size of the polymer particles can range from about 10 nm to about 300 nm, from about 50 nm to about 250 nm, from about 100 nm to about 250 nm, or from about 25 nm to about 250 nm.

In some examples, the polymer (latex) particles have a glass transition temperature higher than 60° C. and an average particle size of 1 nm or more.

In examples of the binder fluid, the polymer particles can be present, based on a total weight of the binder fluid, in an amount ranging from about 1 wt % active to about 40 wt % active. In other more detailed examples, the polymer particles can be present in an amount ranging from about 5 wt % active to about 30 wt % active, from about 12 wt % active to about 22 wt % active, from about 15 wt % active to about 20 wt % active, from about 10 wt % active to about 20 wt % active, or from about 6 wt % active to about 18 wt % active, based on the total weight of the binder fluid.

In addition to the polymer particles, the binder fluid includes a binder fluid vehicle. In one example, the binder fluid vehicle is water. In another example, the binder fluid vehicle includes water and one or more additives, such as co-solvent(s), surfactant(s), antimicrobial(s), viscosity modifier(s), pH adjuster(s), chelating agent(s), anti-kogation agent(s), and the like. In one example, water can be present in an amount ranging from about 30 wt % to 100 wt % of the binder fluid vehicle component-excluding the polymer particles-based on a total weight of the aqueous liquid vehicle. Put another way, the water can be present in an amount ranging from about 60 wt % to about 99 wt %, from about 65 wt % to 90 wt %, or from about 70 wt % to about 85 wt %, based on a total weight of the binder fluid.

The co-solvent can be present in the binder fluid in an amount ranging from about 0.5 wt % active to about 50 wt % active, based on a total weight of the binder fluid. When a single co-solvent is included, the co-solvent that is selected is a plasticizer for the polymer (latex) particles in the binder fluid. When multiple co-solvents are included, at least one of the co-solvents is a plasticizer for the polymer (latex) particles in the binder fluid. Some examples of suitable plasticizing co-solvents include 2-pyrrolidone, dimethyl sulfoxide (DMSO), methyl 4-hydroxybenzoate, dioctyl phthalate, N-methyl-2-pyrrolidone (i.e., N-methyl-pyrrolidone), and mixtures thereof. Other examples of suitable plasticizers include N-2-hydroxyethyl-2-pyrrolidone (i.e., 1-(2-hydroxyethyl)-2-pyrrolidone), urea, ethylene carbonate, propylene carbonate, lactones, diethylene glycol, triethylene glycol, tetraethylene glycol, decalin, gamma-butyrolactone, dimethylformamide, and phenylmethanol.

Examples of other co-solvents that can be used in combination with the plasticizing co-solvent include any of the co-solvents described for the alloying agent.

Any examples of the surfactants set forth for the alloying agent may be used in the binder fluid. Some specific examples include SURFYNOL® SEF (a self-emulsifiable wetting agent based on acetylenic diol chemistry), SURFYNOL® 104 (a non-ionic wetting agent based on acetylenic diol chemistry), or SURFYNOL® 440 (an ethoxylated low-foam wetting agent) (all available from Evonik Degussa); TERGITOL® TMN-6 (a branched secondary alcohol ethoxylate, non-ionic surfactant), TERGITOL® 15-S-5 or TERGITOL® 15-S-7 (each of which is a secondary alcohol ethoxylate, non-ionic surfactant), or DOWFAX® 2A1 or DOWFAX® 8390 (each of which is an alkyldiphenyloxide disulfonate, available from The Dow Chemical Company); CAPSTONE® FS-35 (non-ionic fluorosurfactant from DuPont); or a combination thereof.

The surfactant or combinations of surfactants can be present in the binder fluid in an amount ranging from from about 0.1 wt % active to about 5 wt % active based on the total weight, and in some examples, can be present in an amount ranging from about 0.5 wt % active to about 2 wt % active.

With respect to antimicrobials, any compound set forth for the alloying agent can be included in the binder fluid. In an example, the example binder fluid may include a total amount of antimicrobials that ranges from about 0.0001 wt % active to about 1 wt % active.

Viscosity modifiers and pH adjusters (e.g., acids, bases, or buffers) may also be present, as well as other additives to modify properties of the binder fluid. A desirable pH for the binder fluid ranges from about 3 to about 10, and a desirable viscosity for the binder fluid is any that enables it to be jetted via a thermal and/or piezoelectric inkjet print head. Some examples of the binder fluid have a pH ranging from about 6 to about 10, and other examples of the binder fluid have a pH ranging from about 7 to about 7.5.

Chelating agents, such as EDTA (ethylene diamine tetra acetic acid) or any other example set forth for the alloying agent may be included in the binder fluid. Whether a single chelating agent is used or a combination of chelating agents is used, the total amount of chelating agent(s) in the example binder fluids may range from greater than 0 wt % active to about 2 wt % active based on the total weight of the binder fluid.

Examples of the binder fluid that are to be dispensed from a thermal inkjet printhead may also include from about 0.1 wt % to about 1 wt % of an anti-kogation agent, based on a total weight of the binder fluid. Kogation refers to the deposit of dried solids on a thermal inkjet printhead. An anti-kogation agent can be included to prevent the buildup of dried solids on the printhead. Examples of suitable anti-kogation agents include oleth-3-phosphate (commercially available as CRODAFOS™ O3A or CRODAFOS™ N-3 acid), dextran 500k, CRODAFOS™ HCE (phosphate-ester from Croda Int.), CRODAFOS® N10 (oleth-10-phosphate from Croda Int.), or DISPERSOGEN® LFH (polymeric dispersing agent with aromatic anchoring groups, acid form, anionic, from Clariant), etc.

### Combined Alloying Agent and Binder Agent

The examples disclosed herein describe an alloying agent and a separate binder agent (i.e., binder fluid). Separate agents allow for the patterning of the 3D object (with the binder agent) and the patterning for the site-specific alloyed section(s) of the 3D object to be separately controlled. However, it is to be understood that the alloying element (of the alloying agent) and the polymer (latex) particles (of the binder agent) may be combined into a single alloying/binder agent. The combined alloying/binder agent may include the alloying element, the polymer particles, and any example of the vehicle described herein for the alloying agent and/or the binder agent. This combined alloying/binder agent may be useful, for example, when it is desirable to provide the alloyed composition throughout the 3D object. This combined alloying/binder agent may also be used with a separate binder agent. In this example, the separate binder agent may be used to pattern portion(s) of the 3D object that are not to be alloyed, and the combined alloying/binder agent may be used to pattern portion(s) of the 3D object that are to be alloyed.

### Metal-based Build Materials

In the examples disclosed herein, the build material can include any metal-based build material. Metal-based build materials may be particles of a metal or a metal alloy.

In an example, the metal particles are a single phase metallic material composed of one element. Examples of these metal particles includes titanium, molybdenum, tungsten, or copper. In another example, the metal particles are composed of two or more elements, which may be in the form of a single phase metallic alloy or a multiple phase metallic alloy. Examples of these metal particles include low-to medium-carbon stainless steels, ferrous alloys, or titanium alloys. In low-carbon stainless steel, the carbon level is 0.3% or less. In medium-carbon stainless steel, the carbon level ranges from about 0.31% to about 0.6%. Specific alloy examples can include stainless steel 304/304L (low-carbon), stainless steel GP1 (low-carbon), stainless steel 17-4PH (low-carbon), stainless steel 316/316L (low-carbon), stainless steel 430L (low carbon), titanium 6Al4V, titanium 6Al-4V ELI7, Inconel IN718, Inconel IN625, Maraging Steel MS1, Nickel Alloys HX, CoCr F75 and aluminum alloy 2000, 6000, 7000, and 8000 series. Metal carbides can also be suitable build materials, including tungsten carbide. While several example alloys have been provided, it is to be understood that other alloys may be used as the build material.

The average particle size of the metal-based build material can be similarly sized or differently sized. In one example, the average particle size of the metal-based build material can range from 0.5 μm to 200 μm. In some examples, the particles within a distribution can have a median diameter (D50) ranging from about 2 μm to about 150 μm, from about 1 μm to about 100 μm, from about 1 μm to about 50 μm, etc.

The shape of the build material particles can be spherical, non-spherical, random shapes, or a combination thereof.

The metal-based build material may be used alone in a build material composition, or may be used with other additives. Any of the metal-based build material compositions disclosed herein include from about 80 wt % to 100 wt % of the metal-based build material particles (based on the total weight of the build material composition). In other examples, the metal-based build material particles can be present in the composition in amounts ranging from about 90 wt % to 100 wt %, or from about 95 wt % to 100 wt %, or in an amount of 100 wt %. When the metal particles are present in the build material composition in an amount less than 100 wt %, the remainder of the build material composition may be made up of additives, such as flow aids (e.g., in amounts ranging from about 0.05 wt % to about 0.2 wt %), polymer powder material, etc.

### Three Dimensional Printing Methods

Examples of the printing methods disclosed herein utilize the binder fluid/agent disclosed herein, the alloying agent disclosed herein, and a two-stage heat treatment to generate the 3D object and site-specific alloyed section(s) within the 3D object.

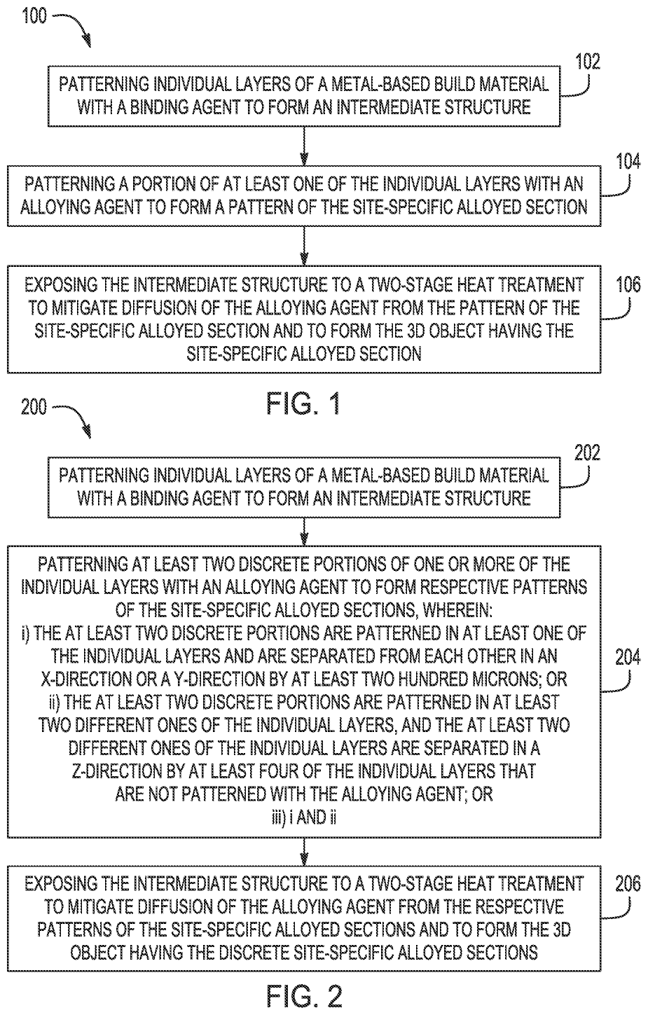

One example of the method 100 is shown in FIG. 1 and includes: based on a digital 3D object model of the 3D object, patterning individual layers of a metal-based build material with a binding agent to form an intermediate structure (reference numeral 102); based on the digital 3D object model, patterning a portion of at least one of the individual layers with an alloying agent to form a pattern of the site-specific alloyed section (reference numeral 104); and exposing the intermediate structure to a two-stage heat treatment to mitigate diffusion of the alloying agent from the pattern of the site-specific alloyed section and to form the 3D object having the site-specific alloyed section (reference numeral 106), the two-stage heat treatment involving: heating the intermediate structure to a first temperature; holding the intermediate structure at the first temperature for a predetermined time, thereby initiating sintering of the metal-based build material; and heating the intermediate structure to a second temperature that is higher than the first temperature.

Another example of the method 200 is shown in FIG. 2 and includes: based on a digital 3D object model of the 3D object, patterning individual layers of a metal-based build material with a binding agent to form an intermediate structure (reference numeral 202); based on the digital 3D object model, patterning at least two discrete portions of one or more of the individual layers with an alloying agent to form respective patterns of the site-specific alloyed sections, wherein: i) the at least two discrete portions are patterned in at least one of the individual layers and are separated from each other in an X-direction or a Y-direction by at least two hundred microns; or ii) the at least two discrete portions are patterned in at least two different ones of the individual layers, and the at least two different ones of the individual layers are separated in a Z-direction by at least four of the individual layers that are not patterned with the alloying agent; or iii) i and ii (reference numeral 204); and exposing the intermediate structure to a two-stage heat treatment to mitigate diffusion of the alloying agent from the respective patterns of the site-specific alloyed sections and to form the 3D object having the discrete site-specific alloyed sections (reference numeral 206).

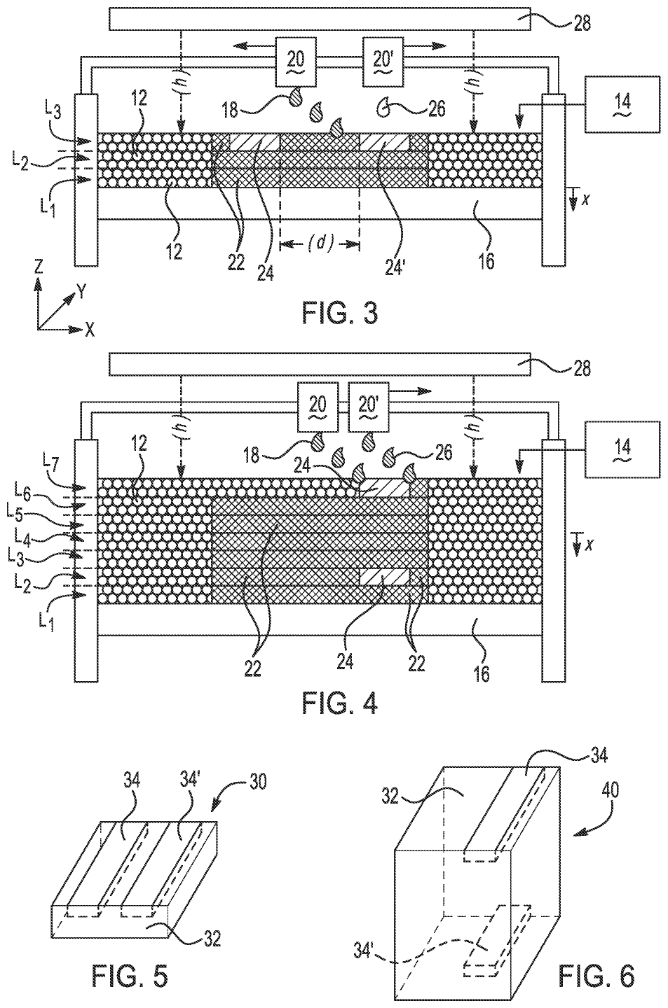

The examples of the method 100, 200 are described further in reference to FIG. 3 and FIG. 4.

As shown in FIG. 3 and FIG. 4, the metal-based build material 12 is deposited from a build material source 14 onto a build area platform 16 where it can be flattened or smoothed, such as by a mechanical roller or other flattening mechanism or technique, to form an individual layer L₁, L₂, L₃ . . . Lₓ. Each layer L₁, L₂, L₃ . . . Lₓ of the metal-based build material 12 has a substantially uniform thickness across the build area platform 16. In an example, the thickness of the build material layer L₁, L₂, L₃ . . . Lₓ ranges from about 90 μm to about 110 μm, although thinner or thicker layers may be used. For example, the thickness of each build material layer L₁, L₂, L₃ . . . Lₓ may range from about 50 μm to about 200 μm. In another example, the thickness of each build material layer L₁, L₂, L₃ . . . Lₓ ranges from about 30 μm to about 300 μm. The layer L₁, L₂, L₃ . . . Lₓ thickness may be about 2× (i.e., 2 times) the average particle size of the metal-based build material 12 at a minimum for finer part definition. In some examples, the layer L₁, L₂, L₃ . . . Lₓ thickness may be about 1.2× the average particle size of the metal-based build material 12.

After each individual layer L₁, L₂, L₃ . . . Lₓ is deposited, it may be patterned with the binder fluid 18 and/or with the binder fluid 18 and the alloying agent 26.

The binder fluid 18 is used to pattern any portion 22 of the individual layer L₁, L₂, L₃ . . . Lₓ that is to become part of the 3D object, but is not to have an alloyed composition. Rather, the composition and microstructure of the portion(s) 22 are dictated by the metal-based build material 12 that is used. In some examples, the portions 22 form the bulk of the 3D object.

The combination of the binder fluid 18 and alloying agent 26 is used to pattern any portion 24, 24′ of the individual layer L₁, L₂, L₃ . . . Lₓ that is to become a site-specific alloyed section of the 3D object. The site-specific alloyed section that forms at the patterned portion 24, 24′ after the two-stage heat treatment has the alloyed composition. The term “alloyed composition” refers to the alloy that forms from the interaction or reaction between the alloying element in the alloying agent 26 and the metal-based build material 12. In some examples, the alloyed composition (and thus the site-specific alloyed section that forms at patterned portion 24, 24′) has a different microstructure after sintering than the microstructure of the rest of the 3D object after sintering (formed at patterned portion 22) due to a phase transformation. The phase transformation results from the interaction or reaction between the alloying element in the alloying agent 26 and the metal-based build material 12. In one example of the 3D printed object, the bulk portion (corresponding to patterned portions 22) has a ferritic microstructure, and the site-specific alloyed section(s) (corresponding to patterned portion(s) 24) has a pearlite microstructure.

The binder fluid 18 can be ejected onto the portions 22, 24, 24′ of the metal-based build material 12 in a particular layer L₁, L₂, L₃ . . . Lₓ from a fluid ejector 20 (such as a thermal inkjet printhead or a piezoelectric inkjet printhead). The fluid ejector 20 allows for (spatially) selective patterning of the metal-based build material 12 layer by layer. The deposition of the binder fluid 18 in a particular layer L₁, L₂, L₃ . . . Lₓ is based on the digital 3D object model (e.g., a computer model) of the 3D object.

The alloying agent 26 can be ejected onto the portions 24, 24′ of the metal-based build material 12 in a particular layer L₁, L₂, L₃ . . . Lₓ from a fluid ejector 20′ (such as a thermal inkjet printhead or a piezoelectric inkjet printhead). The fluid ejector 20′ also allows for (spatially) selective patterning of the metal-based build material 12 layer by layer. The deposition of the alloying agent 26 in a particular layer L₁, L₂, L₃ . . . Lₓ is based on the digital 3D object model (e.g., a computer model) of the 3D object, and in particular, on the desired locations of the site-specific alloyed section within the 3D object.

The specified concentration of the alloying element that is delivered to the portion 24, 24′ depends upon a variety of factors including the concentration of the alloying element in the alloying agent 26, the build material 12 that is used, and the deposition swath. The following equations may be used to determine the alloying element concentration per layer L₁, L₂, L₃ . . . Lₓ of build material 12:

$$[ w ] \times [ l ] \times [ m ] \times [ C ] = alloying element weight per pass ( WPP )$$

$$[ l ] \times [ w ] \times [ t ] \times [ D ] \times [ ρ ] = build material weight ( BMW )$$

$$\frac{WPP \times number of passes}{WPP \times number of passes + BMW} = alloying element concentration per layer$$

where w and l represent the deposition swath width and length, respectively, and are multiplied by the spatial resolution (e.g., dots per inch (dpi)) in the respective direction; m is the mass of each droplet; C is the alloying element mass in the alloying agent 26; [t] is the powder layer thickness; D is the packing density of the metal-based build material 12; and ρ is the density of the metal-based build material 12. The packing density D and the density p are specific to the build material 12 that is used. Depending on the build material 12 characteristics, the packing density D is estimated to change from 0.3 to 0.6.

The specific concentration of the alloying element that is delivered to the portion 24, 24′ may be controlled by varying the deposition resolution width (w) and length (/) from 300-1200 dpi and 300-600 dpi, respectively, adjusting the build material layer thickness (t) (e.g., to as fine as 60 μm), and by adjusting the number of deposition passes (i.e., printing passes).

Some examples of the method include applying the alloying agent 26 over multiple printing passes. The number of printing/deposition passes influences the local alloying element concentration, which affects the alloyed composition that is formed and its properties. Thus, the number of printing/deposition passes can be controlled to tune the microstructure and the hardness of the alloyed composition in the site-specific alloyed section. In an example, the site-specific alloyed section of the 3D object exhibits a hardness correlating with a number of the multiple printing passes. Each pass may deliver a fraction of the total desired amount that is to be applied.

In some instances, it may be desirable to apply the alloying agent 26 in excess of the total desired amount, which may be a predetermined amount that is to react with the metal-based build material 12 during the sintering stage to obtain the alloyed composition at the site-specific alloyed section. Some of the alloying element may be removed (e.g., reacted-away, diffused out of the patterned area, etc.) as a result of sintering, and applying excess can help to ensure the desired alloy composition is generated. In one example, some of a carbon alloying element may react with oxides present in the build material to form gaseous by-products, and overdosing the carbon alloying element can compensate for the loss.

The multiple printing/deposition passes may be performed sequentially, or a pause between printing/deposition passes may be desirable to allow the alloying agent 26 to at least partially penetrate the layer L₁, L₂, L₃ . . . Lₓ of build material 12.

FIG. 3 depicts deposition of the alloying agent 26 in two discrete portions 24, 24′ of the same build material layer L₃. In this example of the method, respective portions 24, 24′ of one of the individual layers L₃ are patterned with the alloying agent 26 in a Y-direction or an X-direction with respect to a build area platform 16; and the respective portions 24, 24′ are separated from each other by at least 200 μm (two hundred microns). This distance, d, may help to ensure that the site-specific alloyed sections that are formed remain isolated from one another in the 3D object. These portions 24, 24′ also have the binder fluid/agent 18 applied thereto. Alternatively, a combined alloying/binder agent may be used to pattern the two discrete portions 24, 24′.

FIG. 4 depicts deposition of the alloying agent 26 in discrete portions 24, 24′ which are located in different build material layers L₂ and L₇. In this example of the method, respective portions 24, 24′ of a plurality of the individual layers, e.g., L₂ and L₇, are patterned with the alloying agent 26 in a Z-direction with respect to a build area platform 16; and the respective portions 24, 24′ are separated by at least four of the individual layers, e.g., L₃ through Le that are not patterned with the alloying agent 26 (but are patterned with the binder fluid 18). The distance separating the discrete portions 24, 24′ in this example will depend upon the thickness of the layers e.g., L₃ through Le between the discrete portions 24, 24′. In one example, the distance is at least 200 μm, which helps to ensure that the site-specific alloyed sections that are formed remain isolated from one another in the 3D object. These portions 24, 24′ also have the binder agent 18 applied thereto. Alternatively, a combined alloying/binder agent may be used to pattern the two discrete portions 24, 24′.

While several layers L₁, L₂, L₃ . . . Lₓ are shown deposited and patterned in FIG. 3 and FIG. 4, it is to be understood that each individual layer L₁, L₂, L₃ . . . Lₓ is deposited and patterned before a subsequent layer L₂, L₃ . . . Lₓ is deposited and patterned.

After each individual layer L₁, L₂, L₃ . . . Lₓ is deposited and patterned with the binder fluid 18 and/or the binder fluid 18 and the alloying agent 26, the build platform 16 can be dropped a distance of (x), which can correspond to at least the thickness of a patterned layer, so that another layer L₂, L₃ . . . Lₓ of the metal-based build material 12 can be added thereon and patterned. The process can be repeated on a layer-by-layer basis until all of the desired layers are patterned in accordance with the digital 3D object model.

Heat (h) can be used, such as from a heat source 28, to remove water and/or co-solvent(s) from the various layers L₁, L₂, L₃ . . . Lₓ throughout the patterning process. This temperature is 120° C. or less. In an example, this temperature may range from about 50° C. to about 120° C. In one example, heat can be applied from overhead, e.g., prior to application of the next layer of metal-based build material 14, or after multiple layers L₁, L₂, L₃ . . . Lₓ are patterned, and/or can be provided by the build area platform 16 from beneath the metal-based build material 12. The build material source 14 can also be used to preheat the metal-based build material 12 prior to dispensing it on the build area platform 16 or a previously applied and patterned layer L₁, L₂, L₃ . . . Lₓ.

The ejector(s) 20, 20′ deposit the binder fluid 18 in a pattern that corresponds to the layers of the 3D object, and can be used to form a 3D intermediate structure in any orientation with respect to the X-Y plane of the build area platform 16, and thus with respect to the layers L₁, L₂, L₃ . . . Lₓ of the build material 12. For example, the 3D intermediate structure can be printed from bottom to top in the Z-direction, or at an inverted orientation (e.g., from top to bottom) in the Z-direction. For another example, the 3D intermediate structure can be printed at an angle or on its side. The orientation of the build within the build material 12 can be selected in advance or even by the user at the time of printing, for example.

After all of the desired portions 22, 24, 24′ of the layers L₁, L₂, L₃ . . . Lₓ Of metal-based build material 12 are patterned with the binder fluid 18 and/or the binder fluid 18 and the alloying agent 26 (or alternatively, the combined binder/alloying agent), low temperature heating all of the individually patterned layers may be performed. This low temperature heating is performed at a temperature ranging from about 120° C. to about 200° C. At this temperature range, heating coalesces the (latex) polymer particles to form a strong, polymer film among the patterned metal-based build material particles, generating a cured structure. This cured structure is the 3D intermediate structure (not shown in FIG. 3 or FIG. 4), and any non-patterned build material 12 surrounding the 3D intermediate structure remains non-cured.

The non-cured build material 12 may be removed from the 3D intermediate structure.

The 3D intermediate structure can then be moved to a heating device, such as a sintering oven, for exposure to the two-stage heat treatment. The two-stage heat treatment involves heating the intermediate structure to a first temperature; holding the intermediate structure at the first temperature for a predetermined time, thereby initiating sintering of the metal-based build material 12; and heating the intermediate structure to a second temperature that is higher than the first temperature. Sintering occurs at each stage of the two-stage heat treatment, where the 3D intermediate structure is partially sintered during the first heating stage and is fully consolidated during the second heating stage. Additionally, using this two-stage heat treatment, the diffusion of the alloying element is mitigated. Thus, during the two-stage heat treatment, the intermediate structure is able to sinter to form the 3D object and the size, shape, and location specificity of the patterned portions 24, 24′ are substantially retained to form the site-specific alloyed sections in the desired locations of the 3D object.

It is to be understood that as the heating device is heating to the first temperature, the network of the polymer particles can thermally degrade, thereby de-binding the 3D intermediate structure.

The first heating temperature is selected so that it is high enough to initiate partial sintering of the metal-based build material 12, but low enough so that diffusion of the alloying element is restricted. As such, at the first heating temperature, partial sintering of the metal-based build material 12 is initiated with negligible diffusion of the alloying element. The first heating temperature is held for a duration ranging from about 120 minutes to about 480 minutes. This time frame helps to achieve good partial sintering, e.g., 60% to 65% 3D object densification, with minimal or no alloying element diffusion due to the lower temperature.

At the second heating temperature (which is higher than the first heating temperature), sintering is continued and the partially sintered metal-based build material 12 particles are consolidated together. The second heating temperature is held for a duration ranging from about 30 minutes to about 90 minutes. Because the metal-based build material 12 particles are sintered prior to being exposed to the higher second heating temperature, the surface-to-volume fraction of the structure/object exposed to the higher second heating temperature is reduced considerably relative to the surface-to-volume fraction of the 3D intermediate structure. The reduced surface-to-volume fraction minimizes or eliminates the surface diffusion of the alloying element during the second heating stage. It is to be understood that bulk diffusion of the alloying element still occurs during the second heating stage. However, bulk diffusion is much slower than surface diffusion, and thus has minimal impact on the size, shape, and location specificity of the site-specific alloyed sections that are formed.

The first and second heating temperatures used in the two-stage heat treatment will depend upon the metal-based build material 12 that is used. In one example when the metal-based build material 12 is a low alloy steel (iron based steel with alloy content of up to 8%) and the alloying element is carbon (e.g., carbon nanoparticles), the first temperature ranges from about 800° C. to about 1000° C.; the predetermined time at which the first temperature is held ranges from about 120 minutes to about 480 minutes; and the second temperature ranges from about 1200° C. to about 1400° C. Other build materials may include: INCONEL® alloys (from Special Metals Corp.), aluminum alloys, titanium alloys, stainless steels, tungsten, molybdenum, and copper; any of which may be alloyed with: carbon, magnesium, vanadium, niobium, titanium, nitrogen, silicon, molybdenum, scandium, zirconium, chromium, manganese, molybdenum, tungsten, boron, or oxide dispersants, e.g., Y₂O₃, FeY₂, La₂O₃, ZrO₂, Ce₂O₃, or MgO.

During the two-stage heat treatment, the alloying element in the patterned portions 24 interact or react with the metal-based build material 12 to form the alloyed composition. The interaction or reaction will depend upon the alloying element and the metal-based build material 12. In one example, the portion 24 of the at least one of the individual layers L₁, L₂, L₃ . . . Lₓ patterned with the alloying agent 26 undergoes a phase change during the two-step heat treatment. As a specific example, carbon in the patterned portions 24 of a low alloy steel build material undergoes a phase transformation from the soft ferritic microstructure to the harder pearlite microstructure, which combines ferrite and carbides arranged in a fine lamellar structure. In this particular example, the bulk portion of the 3D object (formed at portions 22 patterned with the binder fluid 18) has a ferritic microstructure (from the low alloy steel build material), and the site-specific alloyed section (formed at portions 24 patterned with both the binder fluid 18 and the alloying agent 26) has a pearlite microstructure (due to the phase transformation of the carbon alloying element).

FIG. 5 and FIG. 6 respectively illustrate the 3D objects 30, 40 generated from the method shown in FIG. 3 and FIG. 4. The 3D object 30 formed using the method described in reference to FIG. 3 includes the bulk portion 32 and the site-specific alloyed sections 34, 34′ separated from one another in the X-direction. The 3D object 40 formed using the method described in FIG. 4 includes the bulk portion 32 and the site-specific alloyed sections 34, 34′ separated from one another in the Z-direction. In both of the 3D objects 30, 40, the second site-specific alloyed section 34′ is spaced at least four hundred microns from the site-specific alloyed section 34.

In some examples, during the two-stage heat treatment, the heating device can include an inert atmosphere to avoid oxidation of the metal-based build material 12 particles. In one example, the inert atmosphere can be oxygen-free and can include a noble gas, an inert gas, or combination thereof. For example, the inert atmosphere can include a noble gas, or an inert gas (e.g., argon, nitrogen), or a reducing gas (e.g., hydrogen).

To further illustrate the present disclosure, an example is given herein. It is to be understood that this example is provided for illustrative purposes and is not to be construed as limiting the scope of the present disclosure.

### EXAMPLE

One example object was generated using a three-dimensional printing method with a binder fluid, a carbon-based alloying agent, and using the two-stage heat treatment disclosed herein. Two comparative objects were generated with loose powder sintering, where concentrations of steel build material and carbon black powder (1 wt %) were mixed in a cylindrical crucible and exposed to comparative heat treatments.

For the example and comparative examples, the build material was a low alloy steel powder, namely St1.01444.

For the example, the binder fluid and alloying agent compositions that were used are shown in Tables 1 and 2, respectively.

TABLE 1
Binder Fluid

| Component | | Formulation |
|---|---|---|
| Type | Components | (wt %) |
| Co-solvent | 2-methyl-1,3-propanediol | 9.6 |
| | 2-pyrrolidinone | 17.0 |
| Surfactant/ | Tergitol ® 15-S-7 | 0.9 |
| Dispersing aid | Tergitol ® TMN-6 | 0.9 |
| | Capstone ® FS-35 | 0.5 |
| Binder | Acrylic latex dispersion | 16.0 |
| Water | Deionized Water | Balance |

TABLE 2
Alloying Agent

| Component | | Formulation |
|---|---|---|
| Type | Components | (wt %) |
| Co-solvent | 2-methyl-1,3-propanediol | 9.6 |
| | 2-pyrrolidinone | 17.0 |
| Surfactant/ | Tergitol ® 15-S-7 | 0.9 |
| Dispersing aid | Tergitol ® TMN-6 | 0.9 |
| | Capstone ® FS-35 | 0.5 |
| Alloying | Carbon black | 5.0 |
| element | | |
| Water | Deionized Water | Balance |

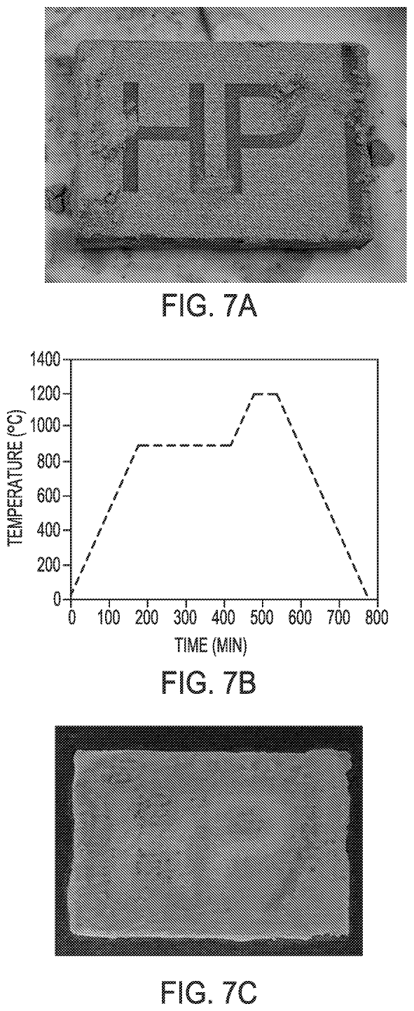

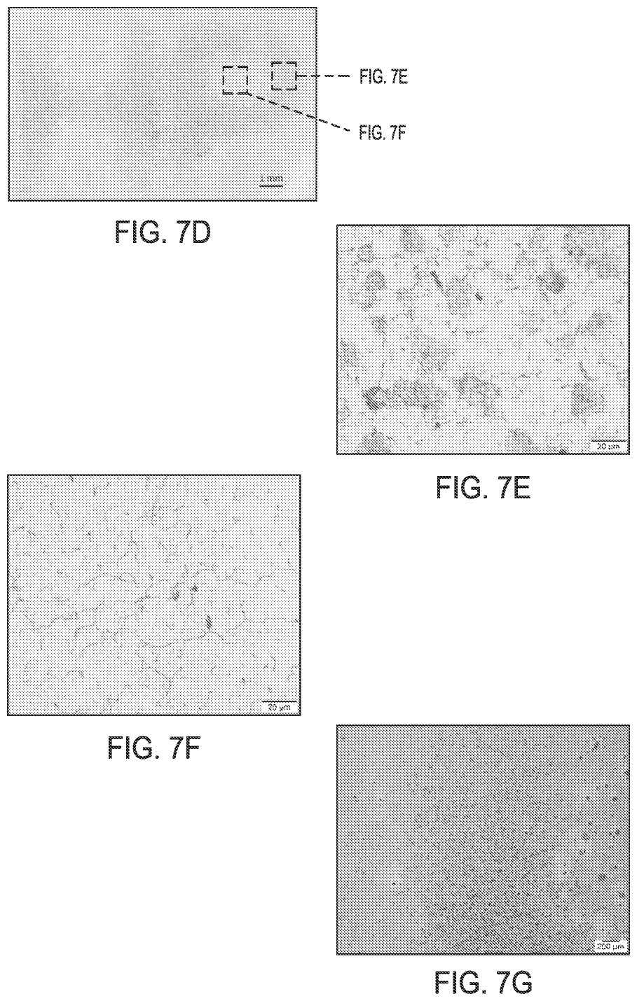

For the example part, 60 μm thick layers of the build material were spread. The total 3D object included 60 layers. The binder fluid was deposited in a rectangular shape in each of the layers. The binder fluid and the alloying agent were deposited together in each of the 60 layers to generate an “HP” pattern for the site-specific alloyed section. Using the equations set forth herein, it was calculated that about 0.936 wt % of the carbon nanoparticles were introduced per layer of the build material over 4 deposition/printing passes in the “HP” pattern. The patterned structure was heated to cure the polymer particles and form the example 3D intermediate structure shown in FIG. 7A. To initiate curing, the patterned structure was exposed to heat from a heat lamp, and the surface temperature of the patterned structure reached a temperature ranging from about 60° C. to about 70° C. (measured with a handheld radiation thermometer). This temperature was maintained for a time ranging from about 20 seconds to about 30 seconds to cure the patterned structure and form the 3D intermediate structure.

The 3D intermediate structure was then heated to about 450° C. for about 180 minutes to react away the binder present within the 3D intermediate structure. This debinding stage was performed before the two-stage heat treatment.

The example 3D intermediate structure was then exposed to the two-stage heat treatment shown in FIG. 7B. As depicted, the temperature of the heating device containing the example 3D intermediate structure was ramped up to 900° C. (the first temperature) over about 175 minutes, and then was held at 900° C. for about 240 minutes. The temperature of the heating device containing the example 3D intermediate structure was then ramped up to 1200° C. (the second temperature) over about 60 minutes, and then was held at 1200° C. for about 60 minutes. The example 3D object was removed from the heating device and was allowed to cool. The resulting example 3D object is shown in FIG. 7C. The HP is the site-specific alloyed section and substantially the same size and shape as the patterned section in the example 3D intermediate structure. Optical microscopy images of the example 3D object are shown in FIG. 7D through FIG. 7G. The “HP” is the site-specific alloyed section (FIG. 7D), and the inset of a portion of the HP (FIG. 7E) clearly illustrates the pearlite structure resulting from the carbon-based alloying agent. The “HP” is this a carbon-rich region. The inset (FIG. 7F) of the remainder of the 3D object surrounding the site-specific alloyed section clearly illustrates the softer ferrite structure of the build material. Thus, the remainder of the object surrounding the “HP” is a carbon-poor region. FIG. 7G depicts a portion of the interface between the “H” (the site-specific alloyed section, which is the carbon-rich region) and the remainder of the 3D object (which is the carbon-poor region). The binder fluid and the alloying agent were deposited so the portion of the “H” shown in FIG. 7G had a width of about 1 mm, and after sintering, the average width was about 1.7 mm. Thus, the site-specific alloyed section of the example 3D object was substantially equivalent to its corresponding patterned portion.

For the first comparative example part, a mixture of the steel build material and carbon black powder (1 wt %) was introduced into the bottom half of a cylindrical crucible, followed by the introduction of additional steel build material without the carbon black powder into the top half of the cylindrical crucible.

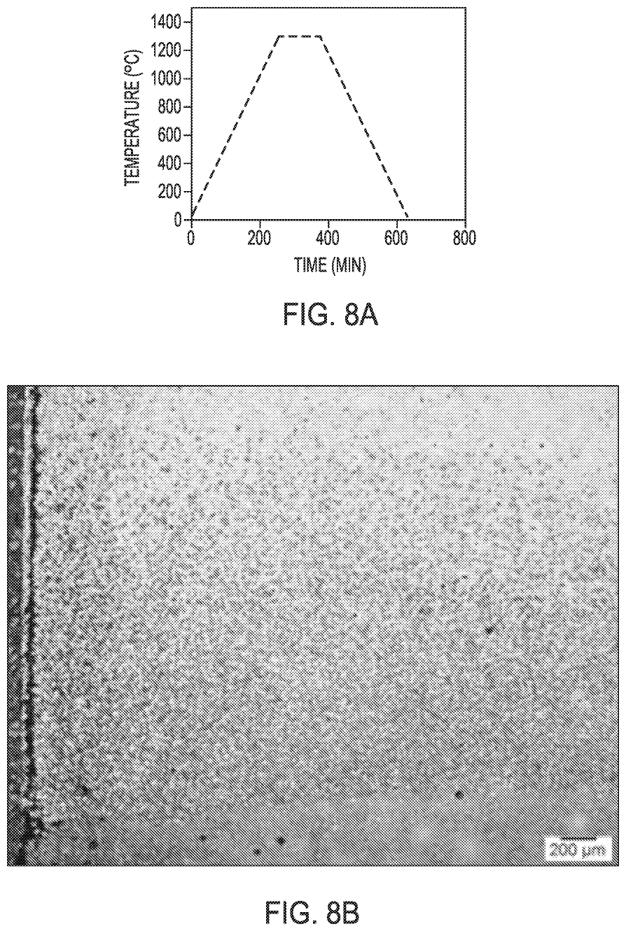

The layered powders were exposed to a single stage heat treatment shown in FIG. 8A to generate a first comparative 3D object. As depicted, the temperature was ramped up to 1300° C. and then was held at 1300° C. for about 120 minutes. The first comparative example 3D object was allowed to cool. An optical microscopy image of a cross-section of the first comparative example 3D object through a vertical plane is shown in FIG. 8B. The top portion of the first comparative 3D object included the softer ferrite structure of the build material, while the bottom portion of the first comparative 3D object included the harder pearlite structure from the introduced carbon nanoparticles. However, FIG. 8B clearly illustrates that the carbon from the bottom half diffused about 2 mm into the top half of the first comparative 3D object.

For the second comparative example part, a mixture of the steel build material and carbon black powder (1 wt %) was introduced into the bottom half of a cylindrical crucible, followed by the introduction of additional steel build material without the carbon black powder on the top half of the cylindrical crucible.

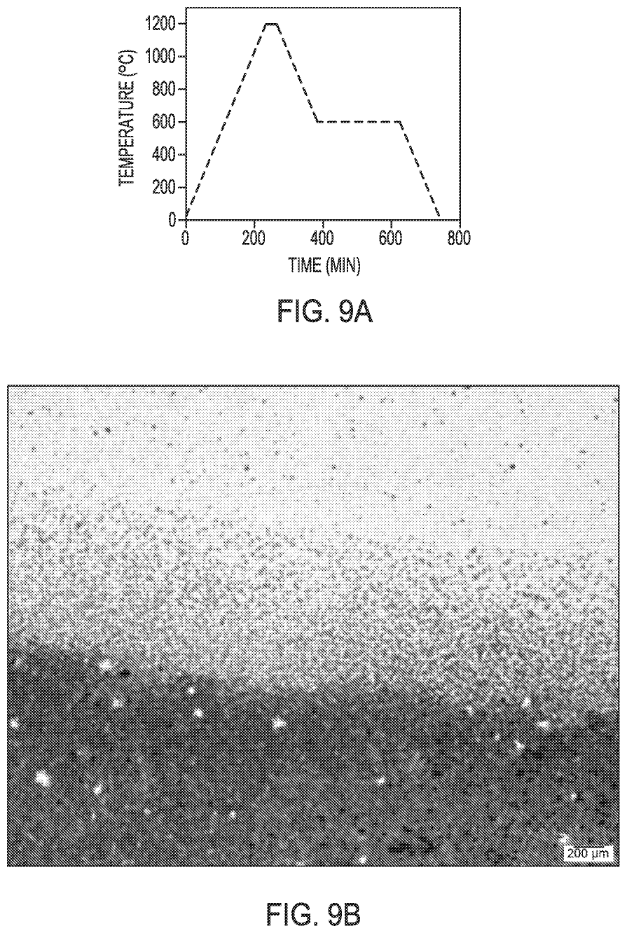

The layered powders were then exposed to a comparative two stage heat treatment shown in FIG. 9A to generate a second comparative 3D object. As depicted, the temperature was ramped up to 1200° C. over about 225 minutes, and then was held at 1200° C. for about 30 minutes. The temperature was then reduced to 600° C. over about 120 minutes, and then was held at 600° C. for about 240 minutes. The second comparative example 3D object was then allowed to cool.

An optical microscopy image of a cross-section of the second comparative example 3D object through a vertical plane is shown in FIG. 9B. The top portion of the second comparative 3D object included the softer ferrite structure of the build material, while the bottom portion of the second comparative 3D object included the harder pearlite structure from the introduced carbon nanoparticles. However, FIG. 9B clearly illustrates that the carbon from the bottom half diffused from about 0.8 mm to about 1 mm into the top half.

These results demonstrate that the two-stage heat treatment disclosed herein reduces diffusion of the alloying agent to create site-specific alloyed sections.

It is to be understood that the ranges provided herein include the stated range and any value or sub-range within the stated range, as if such values or sub-ranges were explicitly recited. For example, from about 1 wt % to about 50 wt % should be interpreted to include not only the explicitly recited limits of from about 1 wt % to about 50 wt %, but also to include individual values, such as about 1.85 wt %, about 22.9 wt %, about 45.2 wt %, etc., and sub-ranges, such as from about 10 wt % to about 50 wt %, from about 1 wt % to about 40 wt %, from about 2.75 wt % to about 3.75 wt %, etc. Furthermore, when “about” is utilized to describe a value, this is meant to encompass minor variations (up to +/−10%) from the stated value.

Reference throughout the specification to “one example”, “another example”, “an example”, and so forth, means that a particular element (e.g., feature, structure, and/or characteristic) described in connection with the example is included in at least one example described herein, and may or may not be present in other examples. In addition, it is to be understood that the described elements for any example may be combined in any suitable manner in the various examples unless the context clearly dictates otherwise.

In describing and claiming the examples disclosed herein, the singular forms “a”, “an”, and “the” include plural referents unless the context clearly dictates otherwise.

While several examples have been described in detail, it is to be understood that the disclosed examples may be modified. Therefore, the foregoing description is to be considered non-limiting.

What is claimed is:

1. A method for generating a site-specific alloyed section of a three- dimensional (3D) object during three-dimensional printing, the method comprising:
based on a digital 3D object model of the 3D object, patterning individual layers of a metal-based build material with a binding agent to form an intermediate structure;
based on the digital 3D object model, patterning a portion of at least one of the individual layers with an alloying agent to form a pattern of the site-specific alloyed section; and
exposing the intermediate structure to a two-stage heat treatment to mitigate diffusion of the alloying agent from the pattern of the site-specific alloyed section and to form the 3D object having the site-specific alloyed section, the two-stage heat treatment involving:
heating the intermediate structure to a first temperature;
holding the intermediate structure at the first temperature for a predetermined time, thereby initiating sintering of the metal-based build material; and
heating the intermediate structure to a second temperature that is higher than the first temperature.

2. The method as defined in claim 1, further comprising applying the alloying agent in excess of a predetermined amount that is to react with the metal-based build material to obtain an alloy composition at the site-specific alloyed section.

3. The method as defined in claim 1, further comprising applying the alloying agent over multiple printing passes.

4. The method as defined in claim 3, wherein the site-specific alloyed section of the 3D object exhibits a hardness correlating with a number of the multiple printing passes.

5. The method as defined in claim 1, wherein the portion of the at least one of the individual layers patterned with the alloying agent undergoes a phase change during the two-stage heat treatment.

6. The method as defined in claim 5, wherein:
a bulk of the 3D object has a ferritic microstructure; and
the site-specific alloyed section has a pearlite microstructure.

7. The method as defined in claim 1, wherein:
respective portions of a plurality of the individual layers are patterned with the alloying agent in a Z-direction with respect to a build area platform; and
the respective portions are separated by at least four of the individual layers that are not patterned with the alloying agent.

8. The method as defined in claim 1, wherein:
respective portions of one of the individual layers are patterned with the alloying agent in a Y-direction or an X-direction with respect to a build area platform; and
the respective portions are separated from each other by at least four hundred microns.

9. The method as defined in claim 1, wherein:
the first temperature ranges from about 800° C. to about 1000° C.;
the predetermined time ranges from about 120 minutes to about 480 minutes; and
the second temperature ranges from about 1200° C. to about 1400° C.

10. A method for generating discrete site-specific alloyed sections of a three-dimensional (3D) object during three-dimensional printing, the method comprising:
based on a digital 3D object model of the 3D object, patterning individual layers of a metal-based build material with a binding agent to form an intermediate structure;
based on the digital 3D object model, patterning at least two discrete portions of one or more of the individual layers with an alloying agent to form respective patterns of the site-specific alloyed sections, wherein:
i) the at least two discrete portions are patterned in at least one of the individual layers and are separated from each other in an X-direction or a Y-direction by at least four hundred microns; or
ii) the at least two discrete portions are patterned in at least two different ones of the individual layers, and the at least two different ones of the individual layers are separated in a Z-direction by at least four of the individual layers that are not patterned with the alloying agent; or
iii) i and ii; and
exposing the intermediate structure to a two-stage heat treatment to mitigate diffusion of the alloying agent from the respective patterns of the site-specific alloyed sections and to form the 3D object having the discrete site-specific alloyed sections.

11. The method as defined in claim 10, wherein:
the two-stage heat treatment involves:
heating the intermediate structure to a first temperature;
holding the intermediate structure at the first temperature for a predetermined time, thereby initiating sintering of the metal-based build material; and
heating the intermediate structure to a second temperature that is higher than the first temperature.

12. The method as defined in claim 11, wherein:
the first temperature ranges from about 800° C. to about 1000° C.;
the predetermined time ranges from about 120 minutes to about 480 minutes; and
the second temperature ranges from about 1200° C. to about 1400° C.

13. The method as defined in claim 10, further comprising applying the alloying agent in excess of a predetermined amount that is to react with the metal-based build material to obtain an alloy composition at each of the discrete site-specific alloyed sections.

14. A 3D printed object, comprising:
a bulk portion having a ferritic microstructure; and
a site-specific alloyed section having a pearlite microstructure.

15. The 3D printed object as defined in claim 14, wherein the 3D printed object includes a second site-specific alloyed section that is spaced at least two hundred microns from the site-specific alloyed section.
